(19) United States
(12) Patent Application Publication
(10) Pub. No.: US 2001/0010061 A1
(43) Pub. Date: Jul. 26, 2001

(54) Communication system, communication method, gateway apparatus, and client

(76) Inventor: Hidehiro Matsumoto, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 09/767,964

(22) Filed: Jan. 24, 2001

(30) Foreign Application Priority Data
Jan. 26, 2000 (JP) 017209/2000

(51) Int. Cl. G06F 15/16

(52) U.S. Cl. 709/249; 709/203; 709/206

(57) ABSTRACT

A communication system includes a client, gateway apparatus, and information source server. The client includes a setting section for setting a parameter and a notification section for notifying the parameter set by the setting section. The gateway apparatus includes an acquisition section for generating an information acquisition request on the basis of the parameter notified by the notification section, an information storage section for temporarily storing information received in response to the acquisition request generated by the acquisition request section, and an information transfer section for transferring the information stored in the information storage section to the client. The information source server includes an information storage section for storing the information acquired by the acquisition request section, and an information transmission section for transmitting the information stored in the information storage section to the gateway apparatus upon reception of the acquisition request.

### BACKGROUND OF THE INVENTION

1. Field of the Invention

The present invention relates to a communication system for acquiring various kinds of information stored in an information source server via a data communication network, a communication method, a gateway apparatus, and a client for acquiring various kinds of information from a client information source server.

2. Description of the Prior Art

With advances in information processing techniques and communication techniques, the users of clients such as computer terminals installed in homes and offices can easily browse information stored in servers constructed on the Internet in which various computer networks are connected to each other. Information access can be made by using information terminals capable of data communication by radio and portable information devices such as portable telephones and personal handy-phone systems (PHSs) as clients, in particular; these devices have been very popular. Conventionally, access to an information source server storing various kinds of information on the Internet is made by using such a radio portable terminal as a client via a gateway (to be abbreviated as a GW hereinafter) apparatus.

FIG. 1 shows an example of the arrangement of a conventional communication system for allowing a client to access an information source server via a gateway apparatus. A client 10 such as a radio portable terminal in a conventional communication system accesses various kinds of information stored in an information source server 11 connected to the Internet by using a radio communication GW apparatus 13 connected to the information source server 11 via a radio data communication network 12. The client 10 is connected to the radio communication GW apparatus 13 via a data communication network 14 capable of data communication by wire or radio.

The accessible range for data communication in the radio data communication network 12 is limited; there are places where no radio waves can reach, e.g., tunnels. In addition, the data transmission capacity in this network is generally smaller than that in a wire data communication network. For this reason, the radio communication GW apparatus 13 incorporates a cache memory 15 to temporarily store information in the information source server 11 for which an access request has been received from the client 10.

Upon reception of an information access request from the client 10 via the data communication network 14, the radio communication GW apparatus 13 acquires required information from the information source server 11 and temporarily stores the information in the cache memory 15 upon packeting it. This makes it possible to provide the information for which the client 10 has made the access request without depending on the state of the radio data communication network 12 which suffers from limitations in terms of data communicable range and data transmission capacity and tends to fall into a disconnected state due to various factors. Even if, for example, the radio data communication network 12 falls into a disconnected state and required information cannot be acquired from the information source server 11, the sent data immediately before the disconnected state can be compensated for by the data stored in the cache memory 15. In addition, the radio communication GW apparatus 13 can control the transmission of packets to be provided so as to allow the client 10 to consecutively receive a packet following the packet received last when the radio data communication network 12 is restored from the disconnected state.

FIG. 2 shows the flow of operation to be performed when the client 10 which executes a software program for browsing various kinds of information in the conventional communication system in FIG. 1 acquires content from a WWW (Word Wide Web) server which is the information source server 11 on the Internet. Upon reception of an address that specifies a WWW server to be accessed from the user, the client 10 transmits a received address instruction 16₁ to the radio communication GW apparatus 13 via the data communication network 14. The radio communication GW apparatus 13 stores this address instruction 16₁ in the cache memory 15 (storage 17), and transmits an address instruction 16₂ as a content acquisition request to the WWW server specified by the address instruction 16₁ via the radio data communication network 12. Upon reception of the address instruction 16₂, the WWW server returns a first content 19₁ to the radio communication GW apparatus 13, if the requested content is divided into a plurality of content data.

Upon reception of the first content 19₁, the radio communication GW apparatus 13 packets the content and stores it in the cache memory 15 (storage 20). In accordance with the stored state of the reception buffer of the client 10, the radio communication GW apparatus 13 transmits the received content data as a first content 19₂ to the client 10 so as to prevent the reception buffer from overflowing.

In the same manner described above, a second content 22₁ and subsequent contents following the first content are transmitted to the radio communication GW apparatus 13, stored in the cache memory 15 (storage 23), and sequentially transferred as a second content 22₂ and the like to the client 10.

Assume that when an nth content 24 following the second content is transmitted from the WWW sever to the radio communication GW apparatus 13, the communication path is disconnected in the radio data communication network 12 (occurrence of disconnected state 25). Upon detection of this disconnected state by timeout processing or the like (detection 26), the radio communication GW apparatus 13 performs re-connection of a communication path to the WWW server (re-connection 27), and generates, to the WWW server, a request to acquire content data that has not arrived after the occurrence of the disconnected state. In accordance with this re-connection request, the WWW server returns an nth content 28₁ to the radio communication GW apparatus 13. Upon reception of this nth content 28₁, the radio communication GW apparatus 13 stores the content as packeted information in the cache memory 15 (storage 29), and transfers it as an nth content 28₂ to the client 10.

FIG. 3 shows the flow of operation to be performed when the client 10 which executes a software program for receiving electronic mail in the conventional communication system in FIG. 1 acquires the content of electronic mail from an electronic mail server which is the information source server 11 on the Internet.

Upon reception of mail box designation, from a user, in which electronic mail addressed to the user is stored, the client 10 transmits mail box designation 31₁ received via the data communication network 14 to the radio communication GW apparatus 13. The radio communication GW apparatus 13 stores information indicating the mail box designated by the mail box designation 31₁ and the user in the cache memory 15 (storage 32), and transmits mail box designation 31₂ to the electronic mail server which is the information source server 11 via the radio data communication network 12. Upon reception of this mail box designation 31₂, the electronic mail server returns first electronic mail 34₁ to the radio communication GW apparatus 13 if pieces of reception mail addressed to the user are stored in the designated mail box.

Upon reception of the first electronic mail 34₁, the radio communication GW apparatus 13 packets the mail and stores it in the cache memory 15 (storage 35). In accordance with the storage state of the reception buffer in the client 10, the radio communication GW apparatus 13 transmits this reception mail data as first mail 34₂ to the client 10 so as to prevent the reception buffer from overflowing.

In the same manner as described above, second mail 37₁ and subsequent mail following the first mail are transmitted to the radio communication GW apparatus 13, stored in the cache memory 15 (storage 38), and sequentially transferred as second mail 37₂ and the like to the client 10.

Assume that when mth mail 40 following the second mail is transmitted from the electronic mail server to the radio communication GW apparatus 13, the communication path is disconnected in the radio data communication network 12 (occurrence of disconnected state 41). Upon detection of this disconnected state by timeout processing or the like (detection 42), the radio communication GW apparatus 13 performs re-connection of a communication path to the electronic mail sever (re-connection 43), and generates, to the electronic mail server, a request to acquire mail data that have not arrived after the occurrence of the disconnected state. In accordance with this re-connection request, the electronic mail server returns mth mail 44₁ to the radio communication GW apparatus 13. Upon reception of the mth mail 44₁, the radio communication GW apparatus 13 stores the mail as packeted information in the cache memory 15 (storage 45), and transfers it as mth mail 44₂ to the client 10.

As described above, in the communication system in which the client 10 which is a radio portable terminal accesses the information source server 11 storing information to be accessed via the radio data communication network 12, the radio communication GW apparatus 13 is so used as to eliminate the instability of a communication state due to the bandwidths and delay amounts of the Internet on which the information source server 11 is constructed and the radio data communication network 12 and radio communication. The radio communication GW apparatus 13 temporarily stores accessed data and monitors the state of the reception buffer on the client side to transfer the temporarily stored data from the information source server 11 to the client 10 so as to prevent the buffer from overflowing. In addition, even if a fault occurs for some reason in the radio data communication network 12 and the communication path is disconnected, the radio communication GW apparatus 13 controls the transfer of content data to be provided for the client 10 by referring to the data stored as packeted information in the cache memory 15 before the disconnection such that the respective contents, pieces of mail, or packets are transferred to the client 10 in a proper order.

In the conventional communication system shown in FIGS. 1 to 3, although the capacity of the cache memory 15 in the radio communication GW apparatus 13 is limited, the radio communication GW apparatus 13 acquires information from the information source server 11 via the radio data communication network 12 without any consideration of the type of the client 10.

Since various kinds of information are acquired from the information source server 11 regardless of the display capability and processing capability of information acquired in the client 10 and the transmission capability of the data communication network 14, the resources of limited communication channels in the radio data communication network 12 are wasted when unnecessary information that cannot be processed by the client 10 is communicated. Even if, for example, the client 10 is only capable of displaying monochrome images, since color image information is transferred from the information source server 11, unnecessary data communication is performed, wasting the storage capacity of the cache memory 15.

Owing to unnecessary data communication, a communication cost and service charge corresponding to a wasteful communication time are imposed on the user of the client 10, resulting in an economical burden. In some case, information intended to be provided by an information provider cannot be accurately provided at a proper timing on the client side because of unnecessary data communication. When a client is to perform mobile communication, the content of an information source server that is accessed must be browsed as quickly as possible or unnecessary electronic mail and content must be removed by handoff control by a host station to which the client is subordinated. In spite of such needs, unnecessary data communication is performed without any consideration of the type of a client, resulting in a great reduction in the throughput of mobile communication.

### SUMMARY OF THE INVENTION

The present invention has been made in consideration of the above situation in the prior art, and has as its object to provide a communication system, communication method, gateway apparatus, and client which can improve convenience to users and also allows effective use of information by performing proper information access in accordance with the various processing capabilities of clients.

In order to achieve the above object, according to the first aspect of the present invention, there is provided a communication system comprising (a) a client including setting means for setting a parameter and notification means for notifying the parameter set by the setting means, (b) a gateway apparatus including acquisition means for generating an information acquisition request on the basis of the parameter notified by the notification means, information storage means for temporarily storing information received in response to the acquisition request generated by the acquisition request means, and information transfer means for transferring the information stored in the information storage means to the client, and (c) a server including information storage means for storing the information acquired by the acquisition request means, and information transmission means for transmitting the information stored in the information storage means to the gateway apparatus upon reception of the acquisition request.

According to the first aspect, in a communication system comprising a client, gateway apparatus, and server, the parameter set by the client is notified to the gateway apparatus, and the gateway apparatus requests the server to acquire information on the basis of the notified parameter, temporarily stores the acquired information, and then transfers it to the client.

According to the second aspect, there is provided communication system comprising (a) a client including creation request means for requesting creation of an agent for information acquisition and notification means for notifying a parameter to be set in the agent created by the creation request means, (b) a gateway apparatus including storage means for storing the parameter for each agent, storage area reservation means for reserving a predetermined storage area in the storage means for each agent for which a creation request is generated by the creation request means, parameter setting means for setting the parameter notified by the notification means in the storage area reserved by the storage area reservation means, and an agent for generating an information acquisition request on the basis of the parameter set by the parameter setting means, temporarily storing information received via a radio data communication network in response to the acquisition request, and transferring the information to the client, and (c) a server including information storage means, connected to the gateway apparatus via the radio data communication network, for storing information for which an acquisition request is generated by the agent in advance, and information transmission means for transmitting the information stored in the information storage means to the gateway apparatus upon reception of the acquisition request.

According to the second aspect, in a communication system comprising a client, gateway apparatus, and server, the client generates a request to create an agent for information acquisition, and also notifies the gateway apparatus of a parameter to be set in the agent. The gateway apparatus reserves a storage area corresponding to the agent for which the creation request has been generated in storage means for storing parameters in correspondence with agents, and sets the notified parameter. The agent generates an information acquisition request to the server on the basis of the set parameter. The agent temporarily stores the information received via a radio data communication network in accordance with this acquisition request and transfers it to the client.

According to the third aspect of the present invention, in the communication system according to second aspect, the client comprises operation stop instructing means for generating an instruction to stop operation of the agent, and the gateway apparatus comprises agent stopping means for stopping the operation of the agent when an operation stop instruction is generated by the operation stop instructing means.

According to the fourth aspect of the present invention, in the communication system according to second or third aspect, the client comprises delete instructing means for generating an instruct to delete the agent, and the gateway apparatus comprises storage area releasing means for releasing a storage area reserved in the storage means in correspondence with a designated agent when the delete instruction is generated by the delete instructing means.

According to the fifth aspect of the present invention, in the communication system according to any one of the first to fourth aspects, the parameter includes at least one of attribute information indicating a display capability and processing capability of the client, attribute information indicating communication capabilities between the client and the gateway apparatus and between the gateway apparatus and the server, and predetermined preference information designated by a user of the client.

According to the sixth aspect of the present invention, there is provided a communication method comprising (a) the creation request step of causing a client for displaying acquired information to request a gateway apparatus to create an agent for information acquisition, (b) the area reservation step of causing the gateway apparatus to reserve a predetermined storage area for each agent whose creation is requested in the creation request step, (c) the parameter setting step of causing the gateway apparatus to set the parameter notified for each agent by the client in the storage area reserved in the area reservation step, (d) the acquisition request step of causing an agent in the gateway apparatus to generate an acquisition request to a server storing various kinds of information on the basis of the parameter set by the parameter setting means, (e) the information transmission step of extracting information for which the acquisition request is generated in the acquisition request step and causing the sever to transmit the information to the gateway apparatus via a radio data communication network, and (f) the transfer step of temporarily storing information transmitted in the information transmission step and causing the gateway apparatus to transfer the information to the client.

According to the sixth aspect, in a communication system comprising a client for, for example, displaying acquired information, a gateway apparatus including an agent which is created in accordance with an instruction from the client and performs information acquisition control on a server, and the server for storing information which the client requests, the client requests the gateway apparatus to create an agent for information acquisition, and the gateway apparatus reserves a predetermined storage area for each agent and sets a parameter notified for each agent from the client in the reserved storage area. The agent in the gateway apparatus generates an acquisition request to the server on the basis of the set parameter, and extracts the information for which the acquisition request has been generated from the sever. The server transmits the information to the gateway apparatus via a radio data communication network. The gateway apparatus temporarily stores the transmitted information and transfers it to the client.

According to the seventh aspect, the communication method according to the sixth aspect further comprises causing the agent to stop operation or release the storage area reserved in correspondence with the agent on the basis of an operation stop instruction or delete instruction from the client.

According to the eighth aspect of the present invention, in the communication method according to the sixth or seventh aspect, the parameter includes at least one of attribute information indicating EL display capability and processing capability of the client, attribute information indicating communication capabilities between the client and the gateway apparatus and between the gateway apparatus and the server, and predetermined preference information designated by a user of the client.

According to the ninth aspect of the present invention, there is provided a gateway apparatus comprising (a) storage means for storing a parameter set for each agent, (b) storage area reservation means for reserving a predetermined storage area in the storage means for each agent when creation of an agent for information acquisition is requested, (c) parameter setting means for setting the parameter in the storage area reserved by the storage area reservation means, and (d) an agent for generating an information acquisition request on the basis of the parameter set by the parameter setting means, temporarily storing information received via a radio data communication network in accordance with the acquisition request, and transferring the information to the request source which has generated the agent creation request.

According to the ninth aspect, a storage area corresponding to the agent for which a creation request has been generated is reserved in storage means for storing parameters in correspondence with agents, and a notified parameter is set in the reserved area. The agent sends an information acquisition request via a radio data communication network on the basis of the set parameter. The agent temporarily stores information received in accordance with this acquisition request and transfers it to the agent creation request source.

According to the 10th aspect of the present invention, in the gateway apparatus according to the ninth aspect, when an operation stop instruction is generated for the agent, operation of the agent is stopped.

According to the 11th aspect of the present invention, in the gateway apparatus according to the ninth or 10th aspect, when a delete instruction is generated for the agent, a storage area reserved in the storage means is released in correspondence with a designated agent.

According to the 12th aspect of the present invention, in the gateway apparatus according to any one of the ninth to 11th aspects, the parameter includes at least one of attribute information indicating a display capability and processing capability of the request source which has generated the agent creation request, attribute information indicating communication capabilities between the request source and the gateway apparatus and between the gateway apparatus and the information transmission source which has generated the acquisition request, and predetermined preference information designated by a user of the request source.

According to the 13th aspect of the present invention, there is provided a client comprising (a) creation request means for requesting creation of an agent for information acquisition, (b) notification means for notifying a parameter to be set in the agent created by the creation request means, and (c) information acquisition means for generating the information acquisition request by using the agent created by the creation request means on the basis of the parameter notified by the notification means, and acquiring information via a radio data communication network.

According to the 13th aspect, an agent for which a creation request is generated to acquire information is notified of a parameter to be set, and an information acquisition request is set via a radio data communication network on the basis of the notified parameter, thus acquiring information.

According to the 14th aspect of the present invention, in the client according to the 13th aspect, operation of the agent created by the creation request means is stopped or the agent is deleted by generating an operation stop instruction or delete instruction for the agent.

According to the 15th aspect of the present invention, in the client according to the 14th aspect, the parameter includes at least one of attribute information indicating a display capability and processing capability of the client, attribute information indicating communication capability with respect to the transmission source which has generated the acquisition request, and predetermined preference information designated by a user.

As is obvious from the above aspects, there can be provided a communication system, communication method, gateway apparatus, and client, which allow reception of information for which an acquisition request has been generated regardless of the state of a radio data communication network, and can efficiently use resources such as the capacity of a cache memory in the gateway apparatus.

According to the third, fourth, seventh, 10th, 11th, or 14th aspect of the present invention, when the client instructs the gateway apparatus to stop the operation of an agent, the operation of the agent in the gateway apparatus is stopped. This allows the user to dynamically change the client in accordance with a purpose and efficiently use the server. When the client instructs the gateway apparatus to delete an agent, the agent in the gateway apparatus releases a storage area reserved in correspondence with the designated agent. With this operation, the agent is deleted. Therefore, agents in the gateway apparatus are dynamically switched from the client, and resources in the apparatus can be allocated to only an agent that needs to operate in the gateway apparatus.

According to the fifth, eighth, 12th, or 15th aspect of the present invention, since only necessary information can be acquired from the sever via the radio data communication network on the basis of at least one of the type and communication capability of the client and preference information, the resources in the gateway apparatus and communication channels in the radio data communication network can be efficiently used, and information acquisition convenient to the user of the client is realized.

The above and many other objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is a block diagram schematically showing an example of the arrangement of a conventional communication system;

FIG. 2 is a sequence chart showing an operation program for making a client acquire a content from an information source server in the conventional communication system;

FIG. 3 is a sequence chart showing an operation program for making the client acquire electronic mail from the information source server in the conventional communication system;

FIG. 4 is a block diagram schematically showing an example of the arrangement of a communication system according to an embodiment of the present invention;

FIG. 5 is a flow chart showing an example of the contents of agent creation processing performed by a client in the embodiment of the present invention;

FIG. 6 is a flow chart showing an example of the contents of agent creation processing performed by a radio communication GW apparatus in the embodiment of the present invention;

FIG. 7 is a sequence chart showing an example of an operation program for agent creation performed by the client and radio communication GW apparatus in the embodiment of the present invention;

FIG. 8 is a sequence chart showing an example of an operation program for an agent stop instruction executed by the client and radio communication GW apparatus in the embodiment of the present invention;

FIG. 9 is a sequence chart showing an example of an operation program for an agent delete instruction executed by the client and radio communication GW apparatus in the embodiment of the present invention;

FIG. 10 is a view showing an example of the definition of a parameter described in a predetermined language and transferred to an agent program in the radio communication GW apparatus in the embodiment of the present invention;

FIG. 11 is a view showing the details of the definition of the operation of an agent in the embodiment of the present invention;

FIG. 12 is a view for explaining an example of the definition of the operation of an agent in the embodiment of the present invention;

FIG. 13 is a view for explaining the definition of an automatic cyclic agent in a WWW sever in the embodiment of the present invention; and

FIG. 14 is a view showing the definition of an electronic mail automatic acquiring agent in an electronic mail server in the embodiment of the present invention.

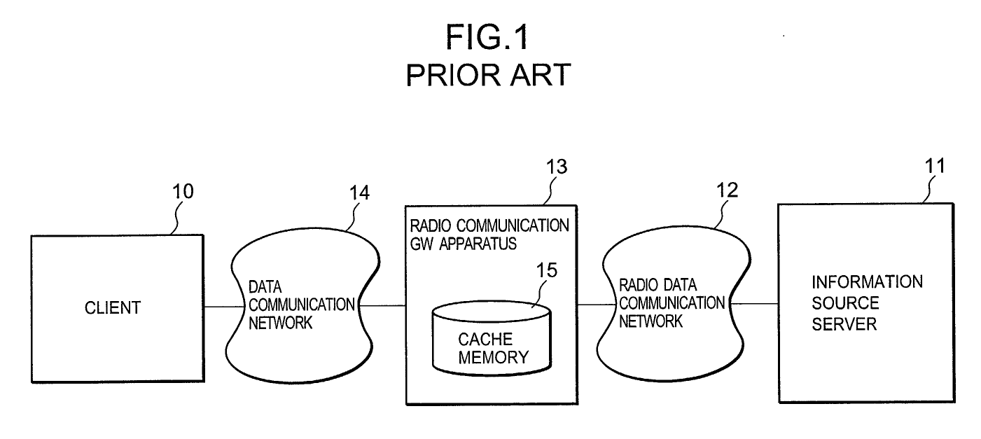

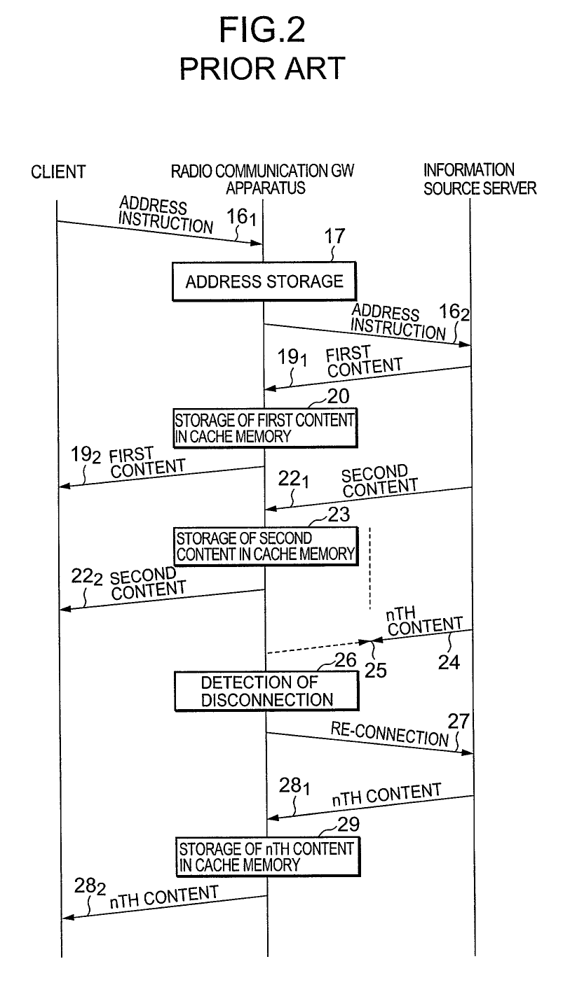

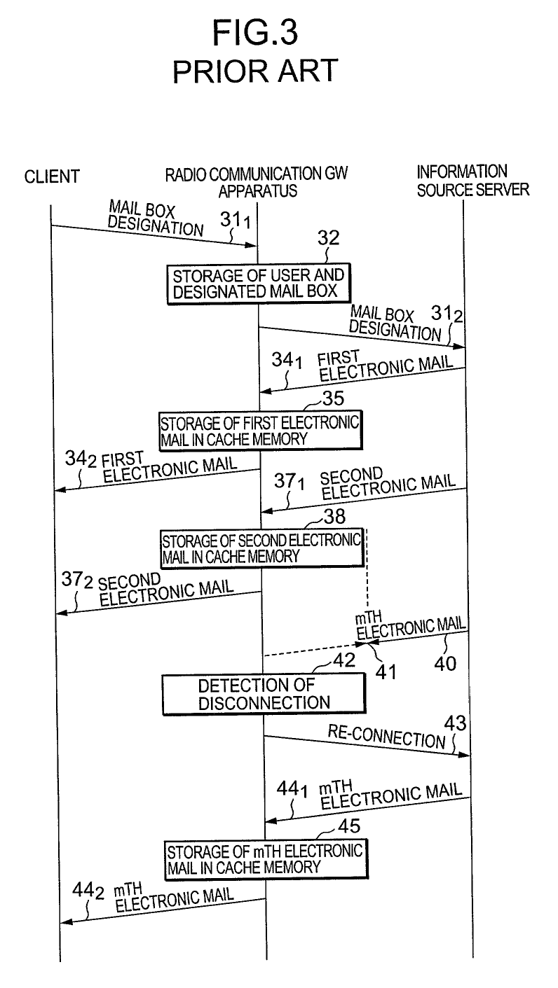

### DETAILED DESCRIPTION OF PREFERRED EMBODIMENT

A preferred embodiment of the present invention will be described in detail below with reference to the accompanying drawings.

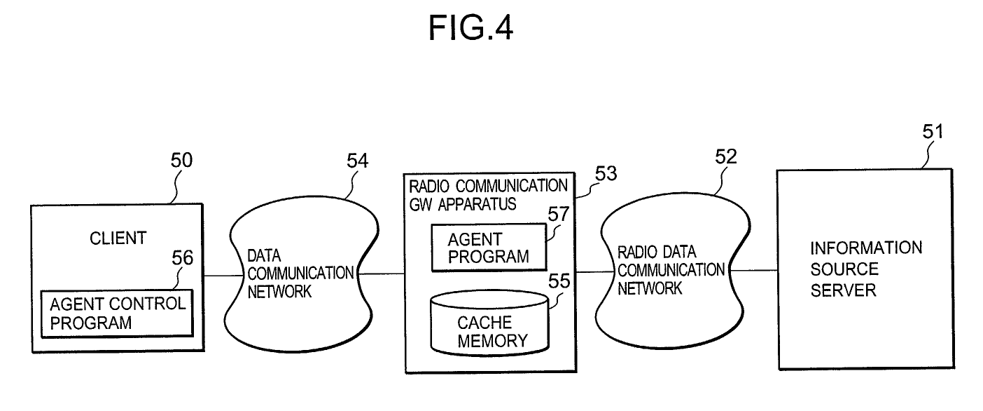

FIG. 4 schematically shows the arrangement of a communication system according to an embodiment of the present invention. In the communication system according to this embodiment, to access various kinds of information stored in an information source server 51 connected to the Internet, a client 50 such as a personal computer or portable telephone uses a radio communication GW apparatus 53 connected to the information source server 51 via a radio data communication network 52. The client 50 is connected to the radio communication GW apparatus 53 via a data communication network 54 capable of data communication by wire or radio.

The radio data communication network 52 is connected to a public network such as the Internet. The accessible range for data communication in the radio data communication network 52 is limited; there are places where no radio waves can reach, e.g., tunnels. In addition, the data transmission capacity in this network is generally smaller than that in a wire data communication network. For this reason, the radio communication GW apparatus 53 incorporates a cache memory 55 to temporarily store information in the information source server 51 for which an access request has been received from the client 50.

Upon reception of an information access request from the client 50 via the data communication network 54, the radio communication GW apparatus 53 acquires required information from the information source server 51 and temporarily stores the information in the cache memory 55 upon packeting it. This makes it possible to provide the information for which the client 50 has made the access request without depending on the state of the radio data communication network 52 which suffers from limitations in terms of data communicable range and data transmission capacity and tends to fall into a disconnected state due to various factors. Even if, for example, the radio data communication network 52 falls into a disconnected state and required information cannot be acquired from the information source server 51, the sent data immediately before the disconnected state can be compensated for by the data stored in the cache memory 55. In addition, the radio communication GW apparatus 53 can control the transmission of packets to be provided so as to allow the client 50 to consecutively receive a packet following the packet received last when the radio data communication network 52 is restored from the disconnected state.

Each of the client 50 and radio communication GW apparatus 53 has a central processing unit (to be abbreviated as CPU hereinafter), and can execute various control operations in accordance with the programs stored in a predetermined storage unit such as a read only memory (ROM).

A characteristic feature of the communication system of this embodiment is that the client 50 includes an agent control program 56, and the radio communication GW apparatus 53 includes an agent program 57 controlled by the agent control program 56. The agent control program 56 registers the attribute information of the client 50, which is set in advance by the manufacturer or the user of the client 50, the communication attribute information of the radio data communication network 52 and data communication network 54, and the user preference information of the client 50 in the agent program 57 in the radio communication GW apparatus 53. The agent program 57 can perform proper communication with the information source server 51 by filtering the information to be acquired from the information source server 51 through the radio data communication network 52 on the basis of the various kinds of information registered by the agent control program 56. In this manner, the capacity of the cache memory 55 and the communication channels of the radio data communication network 52 are effectively used.

The attribute information of the client 50 includes, for example, the capacity of the reception buffer in the client 50, its free space, the size of a display area, the number of bits for display colors, a remaining battery capacity, an input scheme, and a processing capability, which conform to the specifications of CC/PP (Composite Capability/Preference Profile) planned by the world wide web consortium (W3C) or the specifications of UAPROF (User Agent PROFile) examined by the wireless application protocol forum (WAP forum).

The communication attribute information of the radio data communication network 52 and data communication network 54 includes, for example, the transmission capacities of the radio data communication network 52 and data communication network 54, transmission delay amounts, and transmission/reception profiles for designating the half-duplex mode or full-duplex mode, transmission/reception timings, and the like.

The use preference information includes, for example, the type and access frequency of the information source server 51, automatic processing for defining an access timing and the access cycle of the server, and Preference such as filtering that indicates information to be thinned out in accordance with the priority of each information, and complies with the above specifications as well.

The agent function executed by the agent control program 56 in the client 50 and the agent program 57 in the radio communication GW apparatus 53 in the communication system of this embodiment will be described below.

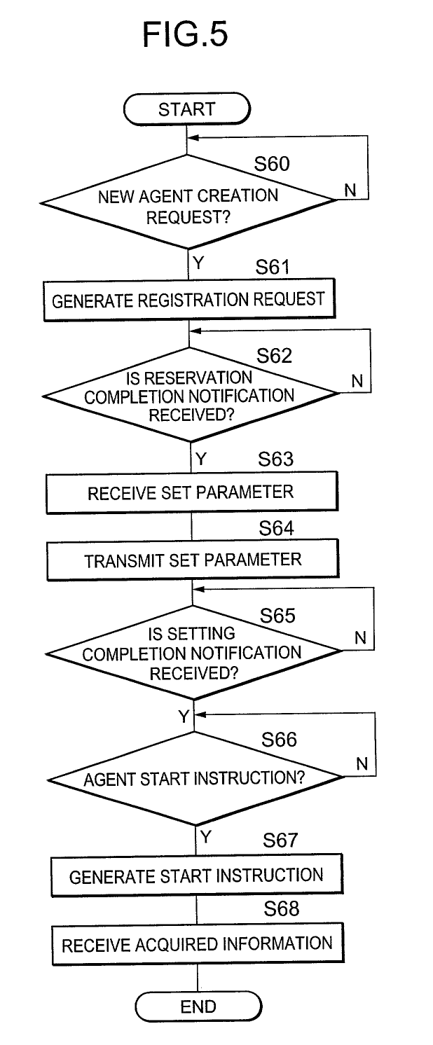

FIG. 5 shows an example of the contents of agent creation processing by the agent control program 56 stored in a predetermined storage unit, which is executed by a CPU (not shown) in the client 50 in this embodiment. The agent control program 56 monitors a creation request for a new agent from, for example, a user (step S60: N). If this request is detected (step S60: Y), the agent control program 56 transmits an agent registration request to request the creation of a new agent to the agent program 57 of the radio communication GW apparatus 53 via the data communication network 54 (step S61). Thereafter, the agent control program 56 waits for a notification, from the agent program 57, which indicates that a storage area for registering a new agent has been reserved and a preparation for the registration of a new agent is completed (step S62: N).

Upon reception of a notification from the agent program 57 which indicates that a storage area for registering a new agent is completed (step S62: Y), the agent control program 56 receives parameters for the agent program 57 which is set by, for example, the user who has made the new agent creation request in step S60 (step S63), and transmits it to the agent program 57 (step S64). The agent control program 56 then waits for the reception of a setting completion notification from the agent program 57 which indicates that the parameters have been set without any abnormality (step S65: N).

When it is notified by the agent program 57 that the set parameters transmitted by the agent program 57 in step S64 have been normally set (step S65: Y), the agent control program 56 waits for an agent start instruction received from the user or generated at a predetermined start timing (step S66: N). If this start instruction is received (step S66: Y), the agent control program 56 sends an agent start instruction to the radio communication GW apparatus 53 via the data communication network 54 (step S67). Subsequently, the agent control program 56 receives information acquired from the information source server 51, which is acquired in accordance with the parameters set by the agent program 57, as needed, and causes a display unit (not shown) to display the information (step S68).

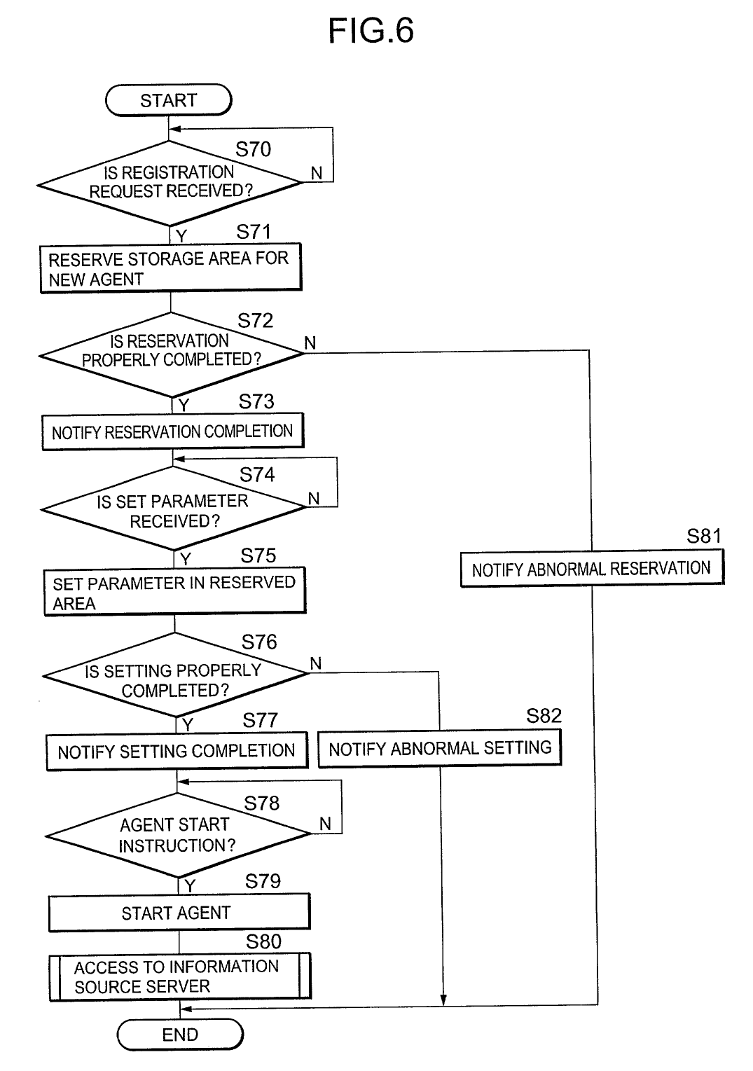

FIG. 6 shows an example of the contents of agent creation processing by the agent program 57 stored in a predetermined storage unit, which is executed by the CPU (not shown) of the radio communication GW apparatus 53 in this embodiment. First of all, the agent program 57 monitors the reception of a new agent registration request from the agent control program 56 of the client 50 (step S70: N). Upon detection of the reception of this request (step S70: Y), the agent program 57 reserves a storage area in a working memory (not shown) which is used to store various set parameters transmitted by the agent control program 56 of the client 50 (step S71).

If a storage area for the new agent for which the registration request has been made is properly reserved (step S72: Y), the agent program 57 notifies the agent control program 56 of the client 50 of the corresponding information (step S73), and waits for the reception of set parameters for the new agent which are transmitted from the agent control program 56 in response to this notification (step S74: N). Upon reception of the set parameters for the new agent transmitted from the agent control program 56 (step S74: Y), the agent program 57 stores the parameters in the storage area reserved in step S71 (step S75).

If the received set parameters are properly stored in the reserved storage area (step S76: Y), the agent program 57 notifies the agent control program 56 of the client of the corresponding information (step S77), and waits for an agent start instruction transmitted by the agent control program 56 (step S78: N). Upon reception of a start instruction for the registered new agent from the agent control program 56 as described above (step S78: Y), the agent program 57 starts the agent (step S79), and acquires only necessary information by making optimal access to the information source server 51, e.g., automatic, cyclic access or periodic reception of information in consideration of the attribute information of the client 50, the communication attribute information of the data communication network 54 and radio data communication network 52, and user preference information, which are the parameters set in the step S75 (step S80).

If a storage area for a new agent cannot be reserved in step S72 (step S72: N), or the set parameters transmitted by the agent control program 56 cannot be properly set in step S76 (step S76: N), the agent program 57 generates a reservation abnormality notification (step S81) and setting abnormality notification (step S82), and transmits the notifications to the client 50 to make the client 50 perform retransmission control for the occurrence of the abnormality. Alternatively, the agent program 57 does not send any completion notification to the client 50 to make the client 50 perform predetermined timeout processing.

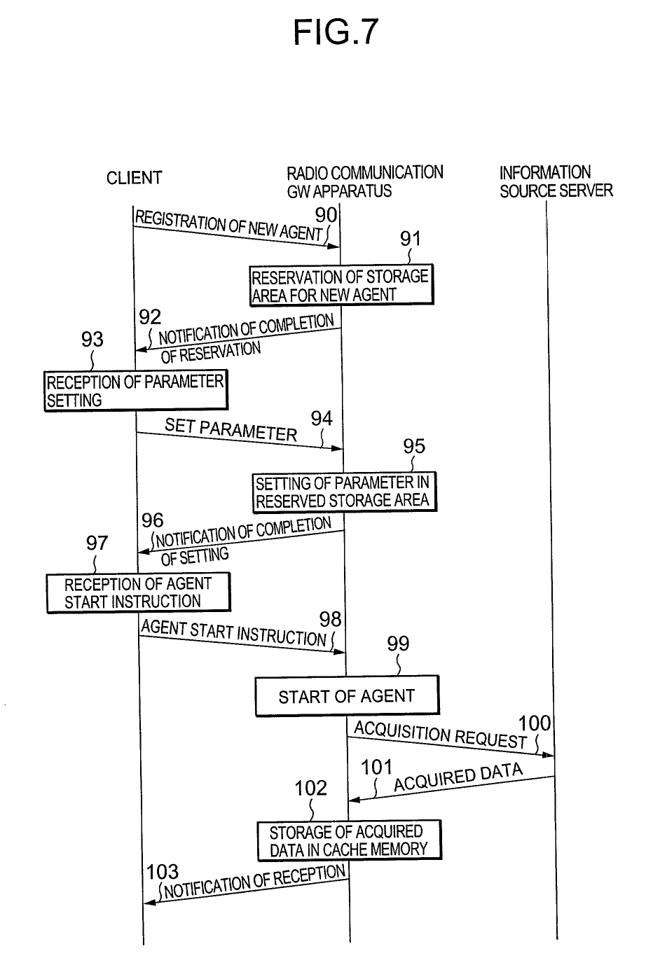

FIG. 7 shows an example of an agent creation sequence executed by the agent control program 56 in the client 50 and the agent program 57 in the radio communication GW apparatus 53. In the communication system of this embodiment, upon reception of a new agent registration request 90 transmitted from the client 50, the radio communication GW apparatus 53 reserves a storage area in a predetermined working memory which is used to store the new agent for which the registration request has been made (reservation 91). With this operation, the creation of the new agent is completed. If a storage area is properly reserved, the client 50 is notified of a reservation completion notification 92 indicating the corresponding information.

The agent control program 56 of the client 50 receives set parameters such as the type of the client 50 and user preference information (reception 93), and notifies the agent program 57 of the radio communication GW apparatus 53 of the set contents as set parameters 94. The agent program 57 of the radio communication GW apparatus 53 stores the received set parameters in the reserved storage area (setting 95). With this operation, setting for the agent is completed. If the parameters are properly set, the agent program 57 notifies the agent control program 56 of the client 50 of a setting completion notification 96 indicating the corresponding information.

Subsequently, the agent control program 56 of the client 50 receives an agent start instruction received from the user or generated at a predetermined start timing (reception 97). Upon reception of the agent start instruction, the agent control program 56 transmits an agent start instruction 98 to the radio communication GW apparatus 53. Upon reception of this instruction, the radio communication GW apparatus 53 starts the agent program 57 (start 99), and transmits an acquisition request 100 for only necessary information to the information source server 51 via the radio data communication network 52 on the basis of the parameters that have already been set.

The information source server 51 returns only the information designated by the received acquisition request 100 as acquired data 101 to the radio communication GW apparatus 53 via the radio data communication network 52. The radio communication GW apparatus 53 stores the acquired data received from the information source server 51 as packeted information in the cache memory 55 (storage 102), and transmits a reception notification 103 or the like in accordance with the buffering state of the reception buffer of the client 50.

In this manner, the agent program 57 of the radio communication GW apparatus 53 accesses the information source server 51 via the radio data communication network 52 in accordance with the parameters set by the agent control program 56 of the client 50. This makes it possible to acquire only necessary portion of optimal information in accordance with the attributes of the client 50, the capability of the data communication network 54 and radio data communication network 52, and the preference of the user of the client 50. The agent control program 56 of the client 50 can dynamically switch agent operations from the client 50 by sending agent stop and delete instructions to the agent program 57 of the radio communication GW apparatus 53.

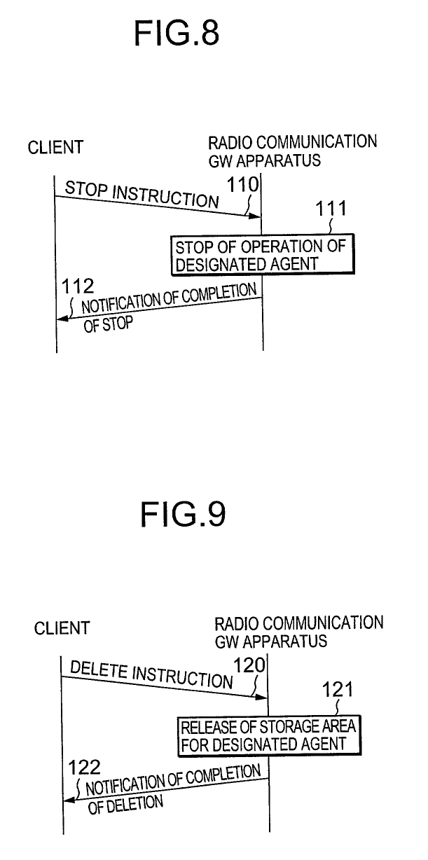

FIG. 8 shows an outline of an agent stop instruction sequence executed by the agent control program 56 of the client 50 and the agent program 57 of the radio communication GW apparatus 53. Upon reception of an agent stop instruction 110 generated by the user of the agent control program 56 of the client 50 or generated at a predetermined timing, the radio communication GW apparatus 53 stops the operation of the agent designated by the stop instruction 110 (step 111). The agent program 57 notifies the agent control program 56 of the client 50 of information indicating the completion of the stop as a stop completion notification 112. This allows the user to dynamically change the client in accordance with a purpose and acquire optimal information for each client in use, thereby allowing the efficient use of the information source server.

FIG. 9 shows an outline of an agent delete instruction sequence executed by the agent control program 56 of the client 50 and the agent program 57 of the radio communication GW apparatus 53. Upon reception of a delete instruction 120 generated by the user through the agent control program 56 of the client 50 or generated at a predetermined timing, the radio communication GW apparatus 53 releases the storage area for storing set parameters, which has already been reserved, in accordance with the agent designated by this delete instruction 120 (release 121), and notifies the agent control program 56 of the client 50 of information indicating the completion of the release operation as a delete completion notification 122. The deleted agent performs no agent operation unless the above agent is generated again.

The above new agent creation will be described next in detail.

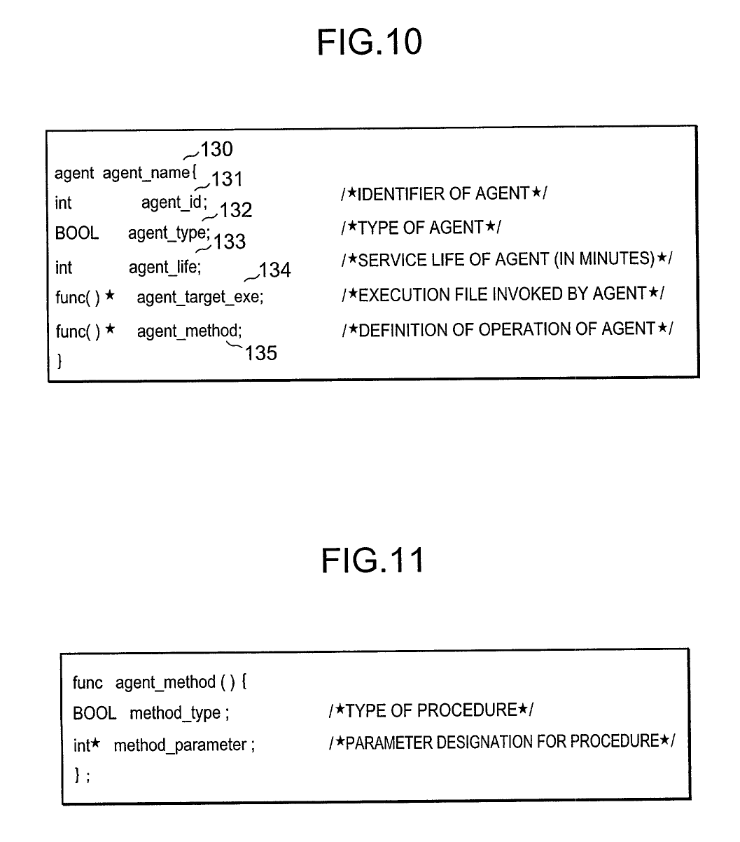

FIG. 10 shows an example of the definition of each parameter described in a predetermined description language and transferred to the agent program 57 of the radio communication GW apparatus 53. More specifically, an “agent_name” 130 defined by an agent type is constituted by an integer type variable “agent_id” 131 for identifying the agent, a Boolean variable “agent_type” 132 indicating the agent type, an “agent_life” 133 indicating the service life of the agent in minutes, an execution file name “agent_target_exe” 134 invoked by the agent, and an “agent_method” 135 indicating the definition of the operation of the agent.

The type of agent indicates, for example, the type of operation of the agent, e.g., WWW browsing software or electronic mail transmission/reception software. The service life of the agent indicates the time interval between the instant at which the agent is started by the agent program installed in the radio communication GW apparatus and the instant at which the agent is deleted, which is not designated by the user. With this operation, since an agent is created only when it is required, the radio communication GW apparatus 53 can effectively use the capacity of the cache memory 55 and the storage area reserved for agent operation. The contents acquired by the agent program 57 upon accessing the information source server 51 with the name of the execution file on the client side, started by the agent, and stored in the cache memory 55 are transferred to the execution file invoked by the agent. The definition of the operation of the agent designates operation intervals and filtering specifications after the start of the agent.

FIG. 11 shows the details of the definition of the operation of the agent in FIG. 10. More specifically, “agent_method” is constituted by “method_type” indicating the type of a procedure and “method_parameter” indicating parameter designation for the procedure.

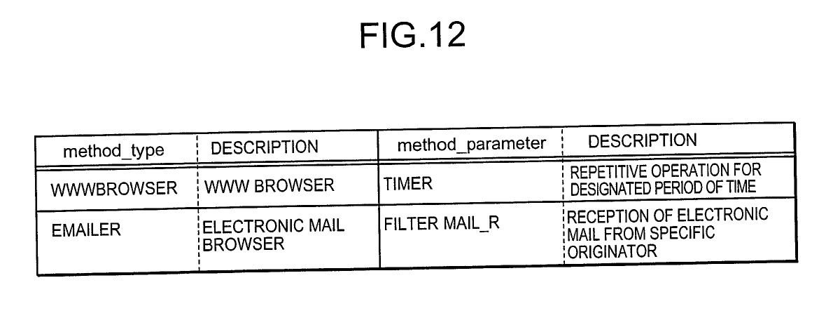

FIG. 12 shows an example of the definition of the operation of the agent in FIG. 11. More specifically, FIG. 12 indicates that if the parameter “method_type” is “WWWBROWSER”, the WWW browser is started, and if it is “EMAILER”, an electronic mail browser which is electronic mail transmission/reception software is started. FIG. 12 also indicates that if the parameter “method_parameter” is “TIMER”, the software designated by “method_type” is repeatedly started for a designated period of time, and if it is “FILER MAIL_R”, electronic mail is received from a specific originator.

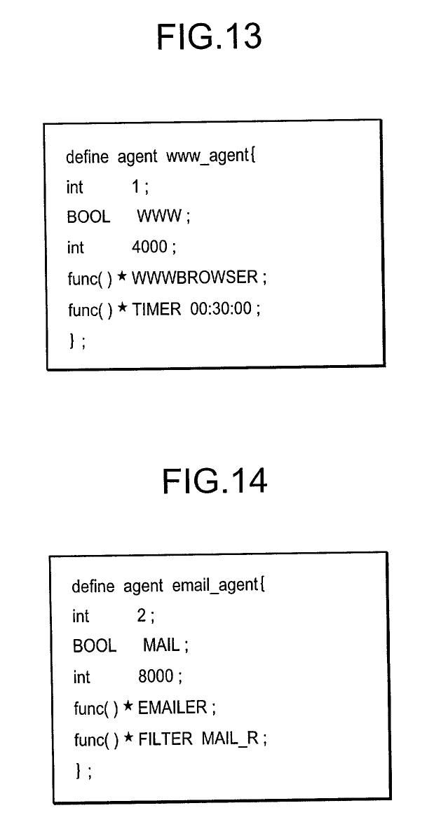

FIG. 13 shows the definition of an automatic cyclic agent of a WWW server according to the definition of the agent type indicated by FIGS. 10 to 12. As shown in FIG. 13, an automatic cyclic agent “www_agent” which is an agent type WWW agent cyclically accesses the WWW browser started in the client 50 in units of 30 min with respect to the WWW browser software identified by an agent identifier “1”, and automatically annihilates the agent program 4,000 min after the start of the program.

FIG. 14 shows the definition of an automatic acquisition agent for reception mail from an electronic mail server according to the definition of the agent type shown in FIGS. 10 to 12. As shown in FIG. 14, an automatic reception mail acquisition agent “email_agent” which is an agent type electronic mail agent starts the electronic mail browser started in the client 50 for the electronic mail transmission/reception software identified by an agent identifier “2” to acquire reception mail by performing filter operation to save only a predetermined originator, and automatically annihilates the agent program 8,000 min after the start of the program.

In this manner, the client 50 transmits various kinds of attribute information set by the user or the like to the radio communication GW apparatus 53 while generating parameters defined in the agent type. The radio communication GW apparatus 53 accesses the information source server 51 via the radio data communication network 52 in accordance with the variables designated by predetermined agent type parameters, thus acquiring only desired information.

With this operation, only necessary information, e.g., the size of the display screen of the client 50 and its processing capability, can be acquired from the information source server 51 in accordance with the preference of the user regardless of the state of the radio data communication network 52. This make is possible to effectively use the capacity of the cache memory 55 of the radio communication GW apparatus 53. In addition, since the operations of agents that operate in the radio communication GW apparatus 53 can be dynamically, switched from the client 50, resources can be allocated to only a necessary agent that operates in the radio communication GW apparatus 53, thus efficiently acquiring only information necessary for the client 50.

In the communication system in this embodiment, the attribute information of a client, the attribute information of a communication network, and user preference information are set in the radio communication GW apparatus 53, and access to the information source server 51 is made via the radio data communication network 52 within a range in which the client 50 can perform proper processing. However, the present invention is not limited to this. The information source server 51 may also acquire various kinds of attribute information based on the UAPROF and CC/PP specifications of the client connected to the radio data communication network. This allows the information provider to effectively provide information for the client and improve the quality of services by analyzing the information to be provided.

According to the above description, in the communication system of this embodiment, a client is connected to only one information source serve via a radio data communication network. However, the present invention is not limited to this. Even if the communication system is configured to allow a client to be connected to a plurality of information source servers as in the Internet, the same effects as described above can be obtained.

In addition, in the communication system of this embodiment, a client sets parameters for a radio communication GW apparatus via the data communication network 54 through which wire or radio communication is performed. However, the present invention is not limited to this. Even if a client and radio communication GW apparatus are integrated into one unit, when access is to be made to an information server via a radio data communication network, only necessary information may be accessed in accordance with the attribute information and the like of the client.

What is claimed is:

1. A communication system comprising:
a client including setting means for setting a parameter and notification means for notifying the parameter set by said setting means;
a gateway apparatus including acquisition means for generating an information acquisition request on the basis of the parameter notified by said notification means, information storage means for temporarily storing information received in response to the acquisition request generated by said acquisition request means, and information transfer means for transferring the information stored in said information storage means to said client; and
an information source server including information storage means for storing the information acquired by said acquisition request means, and information transmission means for transmitting the information stored in said information storage means to said gateway apparatus upon reception of the acquisition request.

2. A communication system comprising:
a client including creation request means for requesting creation of an agent for information acquisition and notification means for notifying a parameter to be set in the agent created by said creation request means;
a gateway apparatus including storage means for storing the parameter for each agent, storage area reservation means for reserving a predetermined storage area in said storage means for each agent for which a creation request is generated by said creation request means, parameter setting means for setting the parameter notified by said notification means in the storage area reserved by said storage area reservation means, and an agent for generating an information acquisition request on the basis of the parameter set by said parameter setting means, temporarily storing information received via a radio data communication network in response to the acquisition request, and transferring the information to said client; and
an information source server including information storage means, connected to said gateway apparatus via the radio data communication network, for storing information for which an acquisition request is generated by said agent in advance, and information transmission means for transmitting the information stored in said information storage means to said gateway apparatus upon reception of the acquisition request.

3. A system according to claim 2, wherein said client comprises operation stop instructing means for generating an instruction to stop operation of said agent, and said gateway apparatus comprises agent stopping means for stopping the operation of said agent when an operation stop instruction is generated by said operation stop instructing means.

4. A system according to claim 2, wherein said client comprises delete instructing means for generating an instruct to delete said agent, and said gateway apparatus comprises storage area releasing means for releasing a storage area reserved in said storage means in correspondence with a designated agent when the delete instruction is generated by said delete instructing means.

5. A system according to claim 3, wherein said client comprises delete instructing means for generating an instruct to delete said agent, and said gateway apparatus comprises storage area releasing means for releasing a storage area reserved in said storage means in correspondence with a designated agent when the delete instruction is generated by said delete instructing means.

6. A system according to claim 1, wherein the parameter includes at least one of attribute information indicating a display capability and processing capability of said client, attribute information indicating communication capabilities between said client and said gateway apparatus and between said gateway apparatus and said server, and predetermined preference information designated by a user of said client.

7. A system according to claim 2, wherein the parameter includes at least one of attribute information indicating a display capability and processing capability of said client, attribute information indicating communication capabilities between said client and said gateway apparatus and between said gateway apparatus and said server, and predetermined preference information designated by a user of said client.

8. A system according to claim 3, wherein the parameter includes at least one of attribute information indicating a display capability and processing capability of said client, attribute information indicating communication capabilities between said client and said gateway apparatus and between said gateway apparatus and said server, and predetermined preference information designated by a user of said client.

9. A system according to claim 4, wherein the parameter includes at least one of attribute information indicating a display capability and processing capability of said client, attribute information indicating communication capabilities between said client and said gateway apparatus and between said gateway apparatus and said server, and predetermined preference information designated by a user of said client.

10. A communication method comprising:
the creation request step of causing a client for displaying acquired information to request a gateway apparatus to create an agent for information acquisition;
the area reservation step of causing the gateway apparatus to reserve a predetermined storage area for each agent whose creation is requested in the creation request step;
the parameter setting step of causing the gateway apparatus to set the parameter notified for each agent by the client in the storage area reserved in the area reservation step;
the acquisition request step of causing an agent in the gateway apparatus to generate an acquisition request to a server storing various kinds of information on the basis of the parameter set by the parameter setting means;
the information transmission step of extracting information for which the acquisition request is generated in the acquisition request step and causing the sever to transmit the information to the gateway apparatus via a radio data communication network; and
the transfer step of temporarily storing information transmitted in the information transmission step and causing the gateway apparatus to transfer the information to the client.

11. A method according to claim 10, further comprising causing the agent to stop operation or release the storage area reserved in correspondence with the agent on the basis of an operation stop instruction or delete instruction from the client.

12. A method according to claim 10, wherein the parameter includes at least one of attribute information indicating a display capability and processing capability of said client, attribute information indicating communication capabilities between said client and said gateway apparatus and between said gateway apparatus and said server, and predetermined preference information designated by a user of said client.

13. A method according to claim 11, wherein the parameter includes at least one of attribute information indicating a display capability and processing capability of said client, attribute information indicating communication capabilities between said client and said gateway apparatus and between said gateway apparatus and said server, and predetermined preference information designated by a user of said client.

14. A gateway apparatus comprising:
storage means for storing a parameter set for each agent;
storage area reservation means for reserving a predetermined storage area in said storage means for each agent when creation of an agent for information acquisition is requested;
parameter setting means for setting the parameter in the storage area reserved by said storage area reservation means; and
an agent for generating an information acquisition request on the basis of the parameter set by said parameter setting means, temporarily storing information received via a radio data communication network in accordance with the acquisition request, and transferring the information to the request source which has generated the agent creation request.

15. An apparatus according to claim 14, wherein when an operation stop instruction is generated for said agent, operation of said agent is stopped.

16. An apparatus according to claim 14, wherein when a delete instruction is generated for said agent, a storage area reserved in said storage means is released in correspondence with a designated agent.

17. An apparatus according to claim 15, wherein when a delete instruction is generated for said agent, a storage area reserved in said storage means is released in correspondence with a designated agent.

18. An apparatus according to claim 14, wherein the parameter includes at least one of attribute information indicating a display capability and processing capability of the request source which has generated the agent creation request, attribute information indicating communication capabilities between the request source and said gateway apparatus and between said gateway apparatus and the information transmission source which has generated the acquisition request, and predetermined preference information designated by a user of the request source.

19. An apparatus according to claim 15, wherein the parameter includes at least one of attribute information indicating a display capability and processing capability of the request source which has generated the agent creation request, attribute information indicating communication capabilities between the request source and said gateway apparatus and between said gateway apparatus and the information transmission source which has generated the acquisition request, and predetermined preference information designated by a user of the request source.

20. An apparatus according to claim 16, wherein the parameter includes at least one of attribute information indicating a display capability and processing capability of the request source which has generated the agent creation request, attribute information indicating communication capabilities between the request source and said gateway apparatus and between said gateway apparatus and the information transmission source which has generated the acquisition request, and predetermined preference information designated by a user of the request source.

21. An apparatus according to claim 17, wherein the parameter includes at least one of attribute information indicating a display capability and processing capability of the request source which has generated the agent creation request, attribute information indicating communication capabilities between the request source and said gateway apparatus and between said gateway apparatus and the information transmission source which has generated the acquisition request, and predetermined preference information designated by a user of the request source.

22. A client comprising:
creation request means for requesting creation of an agent for information acquisition;
notification means for notifying a parameter to be set in the agent created by said creation request means; and
information acquisition means for generating the information acquisition request by using the agent created by said creation request means on the basis of the parameter notified by said notification means, and acquiring information via a radio data communication network.

23. A client according to claim 22, wherein operation of the agent created by said creation request means is stopped or the agent is deleted by generating an operation stop instruction or delete instruction for the agent.

24. A client according to claim 22, wherein the parameter includes at least one of attribute information indicating a display capability and processing capability of said client, attribute information indicating communication capability with respect to the transmission source which has generated the acquisition request, and predetermined preference information designated by a user.

25. A client according to claim 23, wherein the parameter includes at least one of attribute information indicating a display capability and processing capability of said client, attribute information indicating communication capability with respect to the transmission source which has generated the acquisition request, and predetermined preference information designated by a user.
